(19) United States
(12) Patent Application Publication
(10) Pub. No.: US 2016/0116336 A1
(43) Pub. Date: Apr. 28, 2016

(54) OPTICAL MODULE, ELECTRONIC DEVICE, AND METHOD FOR DRIVING OPTICAL MODULE

(71) Applicant: Seiko Epson Corporation, Tokyo (JP)

(72) Inventors: Danjun ZHAO, Shiojiri (JP); Tetsuo TATSUDA, Ina (JP)

(21) Appl. No.: 14/923,557

(22) Filed: Oct. 27, 2015

(30) Foreign Application Priority Data
Oct. 27, 2014 (JP) 2014-218486

(51) Int. Cl. G01J 3/02; G01J 3/28

(52) U.S. Cl. CPC G01J 3/0232; G01J 3/2823; G01J 3/027

(57) ABSTRACT

Provided is an optical module including a wavelength-selective interference filter capable of selecting light of a predetermined wavelength from incident light and changing the wavelength of emitted light, a rolling shutter capturing element in which a light receiving process including a light exposing period for accumulating charges as well as a light blocking period for outputting a detection signal corresponding to the charges accumulated during the light exposing period is sequentially performed in a delayed manner per pixel row configured of a plurality of pixels, and a filter drive unit controlling a wavelength changing drive of the wavelength-selective interference filter.

### BACKGROUND

1. Technical Field

The present invention relates to an optical module, an electronic device, and a method for driving an optical module.

2. Related Art

In the related art, there has been known a spectrometric device as an electronic device including a spectroscopic element capable of acquiring light of a predetermined wavelength from incident light and capable of changing the wavelength to be acquired and a capturing element receiving light acquired by the spectroscopic element. The spectrometric device measures spectra by detecting the intensity of light received by the capturing element (for example, refer to JP-A-2013-17507).

In JP-A-2013-17507, there is disclosed a spectroscopic imaging device including a capturing element alternately repeating a light blocking period and a light exposing period, a spectroscopic element configured to be capable of changing an interspace gap between facing optical substrates, and an interspace gap control unit controlling the interspace gap. This device outputs a control signal by taking into consideration delaying of the spectroscopic element with respect to the output timing of the control signal and finishes a wavelength changing drive before the timing of the end of a predetermined light blocking period of the capturing element.

JP-A-2013-17507, however, does not consider a case of employing a rolling shutter capturing element including a plurality of pixel rows and driving each pixel row at different timings to output detection signals. That is, in a rolling shutter type, drive timings are different for each pixel row, and there may be a pixel row in which a light exposing period of a previous frame is not finished yet when a light exposing period starts in one frame. That is, when a light receiving process is initially performed on a pixel row in a first frame, the light receiving process is immediately performed afterward in a second frame continuously from the first frame. At this time, there may be a pixel row on which the light receiving process is still being performed in the first frame.

When such a rolling shutter light receiving element is employed, spectral images are obtained per frame by repeating a valid frame where the intensity of light exposure is obtained and an invalid frame where the wavelength changing drive is performed. In this case, a changing period in which the wavelength changing drive is performed is from the end of the light exposing period for the last pixel row in a valid frame until the start of the light exposing period for the first pixel row in the subsequent valid frame.

When the changing period is set to be longer while the frame rate is maintained intact, the intensity of light exposure may be insufficient because the light exposing period per one frame is shortened. Meanwhile, the frame rate decreases when both the changing period and the light exposing period are lengthened so as to perform the wavelength changing drive within the changing period and to secure sufficient intensity of light exposure as well.

### SUMMARY

An advantage of some aspects of the invention is to provide an optical module, an electronic device, and a method for driving an optical module capable of preventing a frame rate decrease.

According to an application example of the invention, there is provided an optical module including a spectroscopic element that is capable of selecting light of a predetermined wavelength from incident light and changing the wavelength of emitted light, a rolling shutter capturing element that includes pixels accumulating charges when being exposed to the emitted light and in which a light receiving process including a light exposing period for accumulating charges at the pixels as well as a light blocking period for outputting a detection signal corresponding to the charges accumulated during the light exposing period is sequentially performed in a delayed manner per pixel block configured of a plurality of the pixels, and a spectroscopic control unit that controls a wavelength changing drive of changing the wavelength of the emitted light in the spectroscopic element, in which the capturing element includes, as a plurality of pixel blocks overlapping with a predetermined region set in a light reception region for the emitted light, an initial pixel block where the light receiving process is initially performed and a last pixel block where the light receiving process is lastly performed, and the spectroscopic control unit performs the wavelength changing drive during a period from the end of the light exposing period in the last pixel block until the start of the light exposing period in the subsequent initial pixel block.

In the optical module according to the application example of the invention, the wavelength changing drive is performed in the plurality of pixel blocks of the capturing element overlapping with the predetermined region included in the light reception region for the emitted light during the period from the end of the light exposing period in the last pixel block until the start of the light exposing period in the initial pixel block.

In this case, the light receiving process is sequentially performed in a delayed manner in the plurality of pixel blocks. In addition, a valid frame where a spectral image is obtained and an invalid frame where the wavelength changing drive is performed are repeated to obtain an image corresponding to one frame by driving in two frames.

At this time, the wavelength changing drive is performed during the period from the end of the light exposing period for the last pixel block in the valid frame through the period of the subsequent invalid frame until the start of the light exposing period for the initial pixel block in the subsequent valid frame. Therefore, the wavelength changing drive can be performed even in a part of the valid frame, and a period during which the wavelength changing drive can be performed (changing period) can be lengthened in comparison with a case, for example, where the wavelength changing drive is performed from the end of the light exposing period in the pixel block of all of the pixel blocks where the light receiving process is lastly performed until the start of the light receiving process in the subsequent valid frame. Accordingly, it is possible to prevent a decrease in the frame rate due to performing the wavelength changing drive.

It is preferable that the optical module of the application example further includes a setting unit that obtains the light reception region on the basis of the detection signal from the capturing element and sets the predetermined region on the basis of the light reception region.

In the optical module of the application example, the light reception region is obtained on the basis of the detection signal, and the predetermined region is set on the basis of the light reception region. In this case, the pixel blocks overlapping with the set predetermined region can be target pixel blocks of the light receiving process. Accordingly, even if the light reception region is changed, the target pixel blocks can be set in accordance with the changed light reception region. Therefore, it is possible to prevent a problem such that a part of the image is missing due to the light receiving process not being performed in the pixel blocks that are supposed to be the target pixel blocks according to the change of the light reception region or the predetermined region, and the spectral image can be obtained appropriately.

It is preferable that the optical module of the application example further includes a capture control unit that causes the light receiving process to be performed in all of the pixel blocks which the capturing element includes.

In the optical module of the application example, the wavelength changing drive is performed during the period from the end of the light exposing period in the last pixel block of the pixel blocks overlapping with the predetermined region until the start of the light exposing period of the initial pixel block while the light receiving process is performed in all of the pixel blocks of the capturing element.

In this case, since the capturing element is driven in a usual driving manner in which all of the pixel blocks are targets of the light receiving process, it is possible to prevent adjusting of driving timings of the capturing element and the spectroscopic element from being complicated in comparison with a case where the manner of driving the capturing element is changed.

It is preferable that the optical module of the application example further includes a capture control unit that causes the light receiving process to be performed in the plurality of pixel blocks overlapping with the predetermined region of all of the pixel blocks which the capturing element includes.

In the optical module of the application example, the light receiving process is performed in the pixel blocks overlapping with the predetermined region of all of the pixel blocks of the capturing element.

Even in this case, the changing period can be lengthened in comparison with a case, for example, where the wavelength changing drive is performed from the end of the light exposing period in the pixel block of all of the pixel blocks where the light receiving process is lastly performed until the start of the light receiving process in the subsequent valid frame. That is, the number of target pixel blocks of the light receiving process in one frame can be decreased. As the number of target pixel blocks is smaller, the amount of the changing period shortened in accordance with the cumulative total of delays in time between the pixel blocks can be decreased, and the changing period can be lengthened.

In addition, since the number of target pixel blocks can be decreased, the lengths of the light exposing period and the light blocking period set with respect to a predetermined frame rate and the delay in time between the pixel blocks can be increased in comparison with a case where the light receiving process is performed in all of the pixel blocks. Therefore, the light exposing period and the light blocking period can be set to be longer, and it is possible to prevent a decrease in the frame rate more securely.

Furthermore, as described above, since the number of target pixel blocks can be decreased, the number of detection signals obtained can be decreased, and processing load can be reduced.

According to another application example of the invention, there is provided an electronic device including a spectroscopic element that is capable of selecting light of a predetermined wavelength from incident light and changing the wavelength of emitted light, a rolling shutter capturing element that includes pixels accumulating charges when being exposed to the emitted light and in which a light receiving process including a light exposing period for accumulating charges at the pixels as well as a light blocking period for outputting a detection signal corresponding to the charges accumulated during the light exposing period is sequentially performed in a delayed manner per pixel block configured of a plurality of the pixels, a spectroscopic control unit that controls a wavelength changing drive of changing the wavelength of the emitted light in the spectroscopic element, and a processing unit that performs processing based on the detection signal, in which the capturing element includes, as a plurality of pixel blocks overlapping with a predetermined region set in a light reception region for the emitted light, an initial pixel block where the light receiving process is initially performed and a last pixel block where the light receiving process is lastly performed, and the spectroscopic control unit performs the wavelength changing drive during a period from the end of the light exposing period in the last pixel block until the start of the light exposing period in the subsequent initial pixel block.

In the application example, in the same manner as the above application example related to the optical module, the wavelength changing drive is performed during the period from the end of the light exposing period in the last pixel block of the plurality of pixel blocks of the capturing element overlapping with the predetermined region included in the light reception region for the emitted light until the start of the light exposing period in the initial pixel block.

Accordingly, the changing period during which the wavelength changing drive can be performed can be lengthened, and it is possible to prevent a decrease in the frame rate due to performing the wavelength changing drive.

According to still another application example of the invention, there is provided a method for driving an optical module that includes a spectroscopic element, which is capable of selecting light of a predetermined wavelength from incident light and changing the wavelength of emitted light, and a rolling shutter capturing element, which includes pixels accumulating charges when being exposed to the emitted light and in which a light receiving process including a light exposing period for accumulating charges at the pixels as well as a light blocking period for outputting a detection signal corresponding to the charges accumulated during the light exposing period is sequentially performed in a delayed manner per pixel block configured of a plurality of the pixels, in which the capturing element includes, as a plurality of pixel blocks overlapping with a predetermined region set in a light reception region for the emitted light, an initial pixel block where the light receiving process is initially performed and a last pixel block where the light receiving process is lastly performed, and the method includes accumulating charges in a delayed manner by a predetermined time at the pixels of a plurality of pixel blocks, of all of the pixel blocks that the capturing element includes, including the pixel blocks overlapping with the predetermined region included in the light reception region for the emitted light, and performing a wavelength changing drive of changing the wavelength of the emitted light on the spectroscopic element during a period from the end of the light exposing period in the last pixel block until the start of the light exposing period in the subsequent initial pixel block.

In the application example, in the same manner as the above application example related to the optical module, the wavelength changing drive is performed during the period from the end of the light exposing period in the last pixel block of the plurality of pixel blocks of the capturing element overlapping with the predetermined region included in the light reception region for the emitted light until the start of the light exposing period in the initial pixel block.

Accordingly, the changing period during which the wavelength changing drive can be performed can be lengthened, and it is possible to prevent a decrease in the frame rate due to performing the wavelength changing drive.

### BRIEF DESCRIPTION OF THE DRAWINGS

The invention will be described with reference to the accompanying drawings, wherein like numbers reference like elements.

FIG. 1 is a diagram illustrating a schematic configuration of a spectroscopic camera of a first embodiment according to the invention.

FIG. 2 is a plan view of a wavelength-selective interference filter of the first embodiment.

FIG. 3 is a sectional view of the wavelength-selective interference filter of the first embodiment.

FIG. 4 is a plan view schematically illustrating a capturing face of a capturing element.

FIG. 5 is a block diagram illustrating a schematic configuration of a control system of the spectroscopic camera of the first embodiment.

FIG. 6 is a diagram illustrating drive timings in the spectroscopic camera of the first embodiment.

FIG. 7 is a diagram illustrating drive timings in a spectroscopic camera of the related art.

FIG. 8 is a flowchart illustrating operation of the spectroscopic camera of the first embodiment.

FIG. 9 is a diagram illustrating drive timings in a spectroscopic camera of a second embodiment.

FIG. 10 is a diagram illustrating the relationship between a light reception region and target pixel rows of a light receiving process in one modification example.

### DESCRIPTION OF EXEMPLARY EMBODIMENTS

### First Embodiment

Hereinafter, a spectroscopic camera of a first embodiment according to the invention will be described on the basis of the drawings.

### Schematic Configuration of Spectroscopic Camera

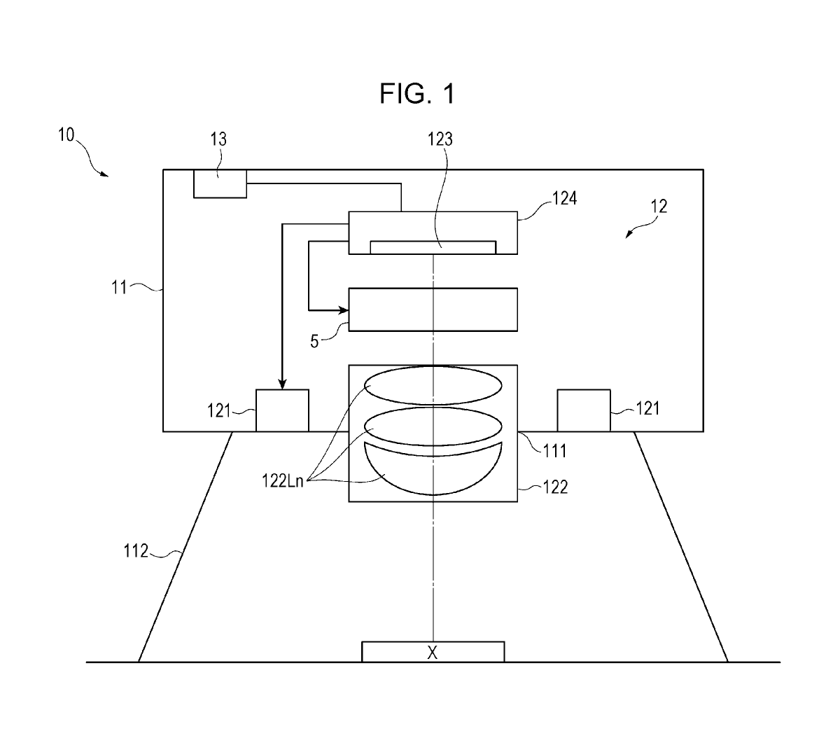

FIG. 1 is a diagram illustrating a schematic configuration of the spectroscopic camera that is one embodiment of an electronic device of the invention.

A spectroscopic camera 10 is a device capturing spectral images in a plurality of wavelengths of a capturing target.

As illustrated in FIG. 1, the spectroscopic camera of the present embodiment is configured to include a casing 11, a capturing module 12 corresponding to an optical module of the invention, a display (not illustrated), and an operating unit 13.

### Configuration of Casing

The casing 11 is formed into a thin box easily accommodatable by a pocket or the like of clothes, such as having a thickness dimension of about 1 cm to 2 cm. The casing 11 includes a capturing window 111 where a light guiding unit 122, described below, of the capturing module 12 is arranged. Light source units 121 described below are arranged around the capturing window 111.

A light blocking member 112 preventing incidence of light other than light from the light source units 121 on the light guiding unit 122 is disposed in the casing 11. The light blocking member 112 is a tubular member enclosing the light source units 121 and the light guiding unit 122 and is tightly abutted at the opposite tip end thereof from the casing 11 on an installation face where a capturing target X is arranged.

### Configuration of Operating Unit

The operating unit 13 is configured of a shutter button disposed in the casing 11, a touch panel disposed in the display, and the like. When a user input takes place, the operating unit 13 outputs an operating signal to a circuit substrate 124 in response to the input.

### Configuration of Capturing Module

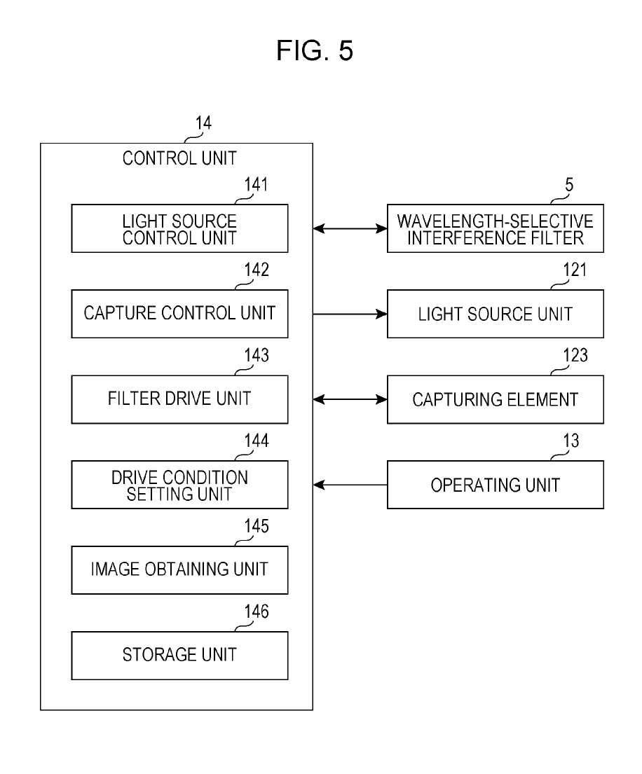

The capturing module 12 includes the light guiding unit 122 disposed to face the capturing window 111, the light source units 121 arranged around the capturing window 111, a wavelength-selective interference filter 5 corresponding to a spectroscopic filter of the invention, and the circuit substrate 124 where a capturing element 123 receiving incident light is disposed. A control unit 14 described below (refer to FIG. 5) is disposed in the circuit substrate 124. The control unit 14 controls operation of the spectroscopic camera 10.

### Configuration of Light Source Unit

Each light source unit 121 includes a plurality of light sources (xenon lamps) arranged annularly along the peripheral portion of the capturing window 111. While xenon lamps are exemplified as a light source in the present embodiment, light sources such as LEDs having a fast response may be employed. Employing xenon lamps or LEDs as a light source enables the light source to emit light in a short amount of time.

### Configuration of Light Guiding Unit

The light guiding unit 122 is configured of a plurality of lenses 122Ln. The light guiding unit 122, for example, includes a telecentric optical system, limits the angle of view to less than a predetermined angle, and forms an image of an inspection target within the angle of view on the capturing element 123.

In addition, it is preferable to dispose a zoom optical system in the light guiding unit 122. Disposing the zoom optical system enables enlarging and reducing of obtained images by, for example, adjusting gaps between lenses in response to a user operation.

### Configuration of Wavelength-Selective Interference Filter

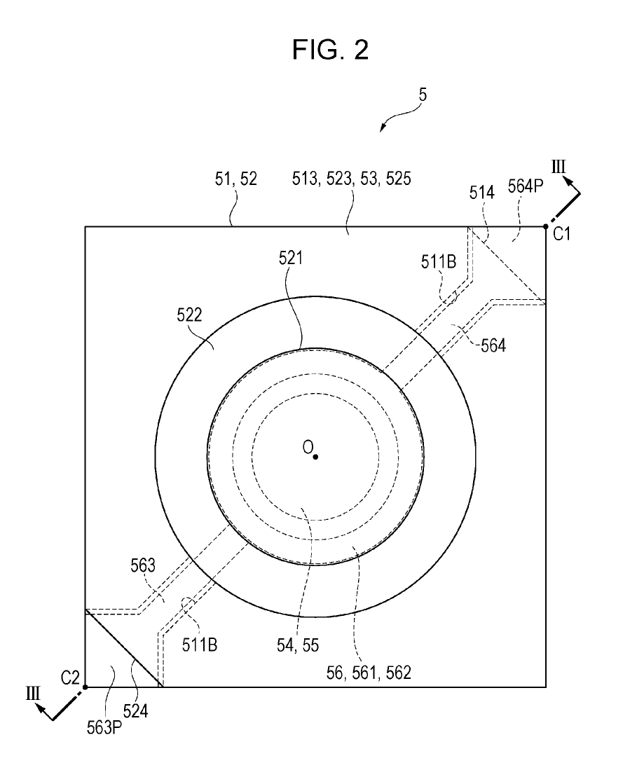

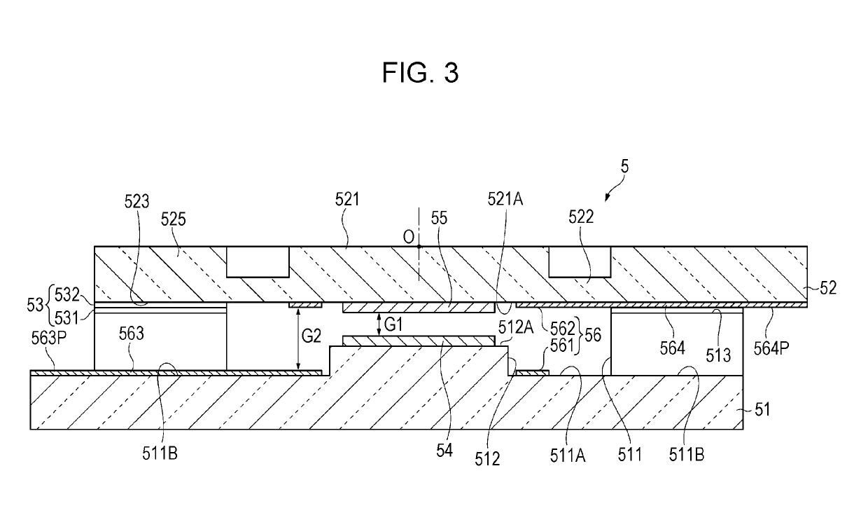

FIG. 2 is a plan view illustrating a schematic configuration of the wavelength-selective interference filter. FIG. 3 is a sectional view schematically illustrating a section of the wavelength-selective interference filter taken along a line III-III of FIG. 2.

The wavelength-selective interference filter 5 is a Fabry-Pérot etalon selectively emitting light of a predetermined wavelength from incident light. The wavelength-selective interference filter 5 includes, for example, rectangular plate-shaped optical members of a fixed substrate 51 formed to have a thickness dimension of, for example, about 500 μm and a movable substrate 52 formed to have a thickness dimension of, for example, about 200 μm. Each of the fixed substrate 51 and the movable substrate 52 is formed of one of various types of glass such as soda lime glass, crystalline glass, quartz glass, lead glass, potassium glass, borosilicate glass, and non-alkali glass; quartz crystal; or the like. The fixed substrate 51 and the movable substrate 52 are integrally configured by bonding a first bonding portion 513 of the fixed substrate 51 and a second bonding portion 523 of the movable substrate 52 with a bonding film 53 (a first bonding film 531 and a second bonding film 532) configured of, for example, a plasma polymer film including a siloxane as a main component.

A fixed reflective film 54 and a movable reflective film 55 are respectively disposed in the fixed substrate 51 and the movable substrate 52. The fixed reflective film 54 and the movable reflective film 55 are arranged to face each other through an inter-reflective film gap G1. An electrostatic actuator 56 employed to adjust (change) the size of the inter-reflective film gap G1 is disposed in the wavelength-selective interference filter 5. The electrostatic actuator 56 is configured of a fixed electrode 561 disposed in the fixed substrate 51 and a movable electrode 562 disposed in the movable substrate 52. The fixed electrode 561 and the movable electrode 562 face each other through an inter-electrode gap G2. The fixed electrode 561 and the movable electrode 562 may be configured to be directly disposed on the respective surfaces of the fixed substrate 51 and the movable substrate 52 or may be configured to be disposed thereon through other film members. The size of the inter-electrode gap G2 is greater than the size of the inter-reflective film gap G1.

In a filter plan view such as illustrated in FIG. 2 obtained by viewing the wavelength-selective interference filter 5 from the direction of thickness of the fixed substrate 51 (movable substrate 52), plan view centers O of the fixed substrate 51 and the movable substrate 52 match the centers of the fixed reflective film 54 and the movable reflective film 55 and match the center of a movable portion 521 described below.

In the description below, a filter plan view will refer to a plan view viewed from the direction of thickness of either the fixed substrate 51 or the movable substrate 52, that is, a plan view obtained by viewing the wavelength-selective interference filter 5 from the direction in which the fixed substrate 51, the bonding film 53, and the movable substrate 52 are laminated.

### Configuration of Fixed Substrate

An electrode arranged groove 511 and a reflective film installed portion 512 are formed by etching in the fixed substrate 51. The fixed substrate 51 is formed to have a greater thickness dimension than the movable substrate 52. Thus, the fixed substrate 51 is not bent by electrostatic attraction generated when voltage is applied between the fixed electrode 561 and the movable electrode 562 or by internal stress of the fixed electrode 561.

A notched portion 514 is formed at a vertex C1 of the fixed substrate 51. A movable electrode pad 564P described below is exposed on the fixed substrate 51 side of the wavelength-selective interference filter 5.

The electrode arranged groove 511 is formed into a ring centered at the plan view center O of the fixed substrate 51 in the filter plan view. The reflective film installed portion 512 is formed to protrude toward the movable substrate 52 from the center portion inside the electrode arranged groove 511 in the plan view. The bottom face of the electrode arranged groove 511 serves as an electrode installed face 511A where the fixed electrode 561 is arranged. The protruding tip end face of the reflective film installed portion 512 serves as a reflective film installed face 512A.

Electrode drawn grooves 511B extending from the electrode arranged groove 511 toward vertices C1 and C2 of the periphery of the fixed substrate 51 are disposed in the fixed substrate 51.

The fixed electrode 561 is disposed on the electrode installed face 511A of the electrode arranged groove 511. More specifically, the fixed electrode 561 is disposed in a region of the electrode installed face 511A facing the movable electrode 562 of the movable portion 521 described below. Alternatively, an insulating film for imparting insulating properties between the fixed electrode 561 and the movable electrode 562 may be configured to be layered on the fixed electrode 561.

A fixed drawn electrode 563 extending from the periphery of the fixed electrode 561 toward the vertex C2 is disposed in the fixed substrate 51. The extending tip end portion (part positioned at the vertex C2 of the fixed substrate 51) of the fixed drawn electrode 563 constitutes a fixed electrode pad 563P connected to the circuit substrate 124.

While the present embodiment is illustrated by the configuration in which one fixed electrode 561 is disposed on the electrode installed face 511A, it is also possible to employ, for example, a configuration in which two electrodes concentrically centered at the plan view center O are disposed on the electrode installed face 511A (dual electrode configuration).

The reflective film installed portion 512, as described above, is formed into a substantial cylinder having a smaller diametral dimension than the electrode arranged groove 511 on the same axis as the electrode arranged groove 511 and includes the reflective film installed face 512A where the reflective film installed portion 512 faces the movable substrate 52.

The fixed reflective film 54 is installed in the reflective film installed portion 512 as illustrated in FIG. 3. Examples that can be employed as the fixed reflective film 54 include a film made of metal such as Ag and a film made of an alloy such as an Ag alloy. Alternatively, for example, a dielectric multilayer film including a high-refractive layer of TiO₂ and a low-refractive layer of SiO₂ may be employed. Further alternatively, a reflective film including a metal film (or an alloy film) layered on a dielectric multilayer film, a reflective film including a dielectric multilayer film layered on a metal film (or an alloy film), a reflective film of a laminate of a single refractive layer (TiO₂, SiO₂, or the like) and a metal film (or an alloy film), or the like may be employed.

An anti-reflective film may be formed at a position on the light incident face (face where the fixed reflective film 54 is not disposed) of the fixed substrate 51, the position corresponding to the fixed reflective film 54. The anti-reflective film can be formed by alternately laminating a low refractive index film and a high refractive index film. The anti-reflective film decreases light reflectance and increases light transmittance on the surface of the fixed substrate 51.

A part of the face of the fixed substrate 51 facing the movable substrate 52 where the electrode arranged groove 511, the reflective film installed portion 512, and the electrode drawn grooves 511B are not formed by etching constitutes the first bonding portion 513. The first bonding film 531 is disposed in the first bonding portion 513. As described above, the fixed substrate 51 and the movable substrate 52 are bonded together by bonding the first bonding film 531 to the second bonding film 532 disposed in the movable substrate 52.

### Configuration of Movable Substrate

The movable substrate 52, in the filter plan view such as illustrated in FIG. 2, includes the circular movable portion 521 centered at the plan view center O, a holding portion 522 holding the movable portion 521 on the same axis as the movable portion 521, and a substrate peripheral portion 525 disposed on the outside of the holding portion 522.

In addition, in the movable substrate 52, as illustrated in FIG. 2, a notched portion 524 is formed in correspondence with the vertex C2, and the fixed electrode pad 563P is exposed in a view of the wavelength-selective interference filter 5 viewed from the movable substrate 52 side.

The movable portion 521 is formed to have a greater thickness dimension than the holding portion 522. For example, the movable portion 521 is formed to have the same thickness dimension as the movable substrate 52 in the present embodiment. The movable portion 521 is formed to have a greater diametral dimension than at least the periphery of the reflective film installed face 512A in the filter plan view. The movable electrode 562 and the movable reflective film 55 are disposed in the movable portion 521.

In the same manner as the fixed substrate 51, an anti-reflective film may be formed on the opposite face of the movable portion 521 from the fixed substrate 51. Such an anti-reflective film can be formed by alternately laminating a low refractive index film and a high refractive index film. The anti-reflective film can decrease light reflectance and increase light transmittance on the surface of the movable substrate 52.

The movable electrode 562 faces the fixed electrode 561 through the inter-electrode gap G2 and is formed into a ring having the same shape as the fixed electrode 561. The movable substrate 52 includes a movable drawn electrode 564 extending from the periphery of the movable electrode 562 toward the vertex C1 of the movable substrate 52. The extending tip end portion (part positioned at the vertex C1 of the movable substrate 52) of the movable drawn electrode 564 constitutes the movable electrode pad 564P connected to the circuit substrate 124.

The movable reflective film 55 is disposed in the center portion of a movable face 521A of the movable portion 521 to face the fixed reflective film 54 through the inter-reflective film gap G1. A reflective film having the same configuration as the fixed reflective film 54 is employed as the movable reflective film 55.

While the present embodiment is illustrated by the example in which the size of the inter-electrode gap G2 is greater than the size of the inter-reflective film gap G1 as described above, the invention is not limited to this. For example, it is also possible to employ a configuration in which the size of the inter-reflective film gap G1 is greater than the size of the inter-electrode gap G2 depending on the wavelength region of target light when, for example, infrared rays or far-infrared rays are employed as the target light.

The holding portion 522 is a diaphragm enclosing the movable portion 521 and is formed to have a smaller thickness dimension than the movable portion 521. Such a holding portion 522 is more likely to bend than the movable portion 521. Thus, slight electrostatic attraction can displace the movable portion 521 toward the fixed substrate 51. At this time, since the movable portion 521 has a greater thickness dimension than the holding portion 522 and has high rigidity, the shape of the movable portion 521 does not change even if the holding portion 522 is pulled toward the fixed substrate 51 by electrostatic attraction. Therefore, the movable reflective film 55 disposed in the movable portion 521 does not bend as well, and the state of parallelism between the fixed reflective film 54 and the movable reflective film 55 can be maintained at all times.

While the present embodiment is illustrated by the holding portion 522 shaped as a diaphragm, the invention is not limited to this. For example, it is also possible to employ a configuration in which beam-shaped holding portions are arranged at equiangular intervals to be centered at the plan view center O.

The substrate peripheral portion 525 is disposed on the outside of the holding portion 522 in the filter plan view as described above. The face of the substrate peripheral portion 525 facing the fixed substrate 51 includes the second bonding portion 523 facing the first bonding portion 513. The second bonding film 532 is disposed in the second bonding portion 523. As described above, the fixed substrate 51 and the movable substrate 52 are bonded together by bonding the second bonding film 532 to the first bonding film 531.

In the wavelength-selective interference filter 5 configured as such, light guided by the light guiding unit 122 is incident on a facing region where the fixed reflective film 54 faces the movable reflective film 55, and light of a wavelength corresponding to the dimensions of the gap G1 set in accordance with a target wavelength is emitted outside.

### Configuration of Capturing Element

The capturing element 123 includes a plurality of pixel rows (for example, n rows of Line 1 to Line n, each pixel row corresponding to a pixel block of the invention) arranged in one direction, each pixel row including a plurality of pixels arranged into an array on a two-dimensional plane. The capturing element 123 employs a rolling shutter method. That is, the capturing element 123 performs a light receiving process, which includes a light exposing period for accumulating charges corresponding to the intensity of light exposure by a predetermined period of time of light exposure as well as a light blocking period for outputting a detection signal corresponding to the accumulated charges during a predetermined period of time of light blocking and for resetting the accumulated charges and obtains the detection signal corresponding to the intensity of light exposure, by delaying the light receiving process by a predetermined period of time (for example, a time required for transmission of charges) for each pixel row. A CMOS image sensor, for example, is employed as such a capturing element 123.

### Light Reception Region and Image Region of Capturing Element

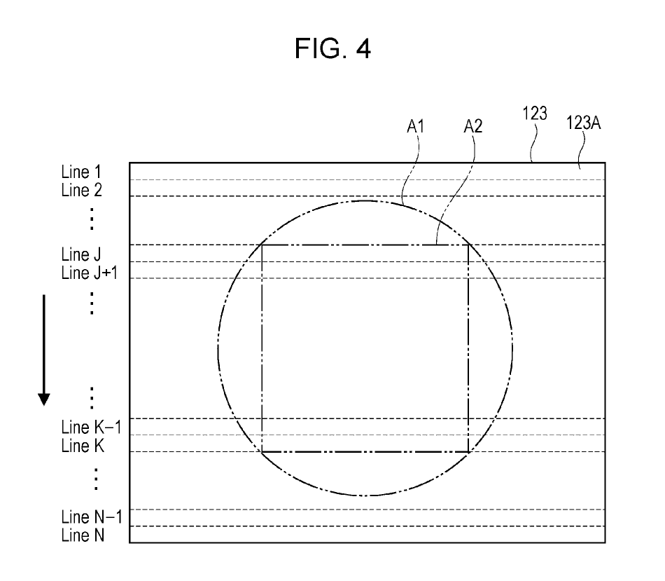

FIG. 4 is a diagram schematically illustrating a light receiving face 123A of the capturing element 123 in an enlarged manner.

In the capturing element 123, light guided by the light guiding unit 122 and passing through the wavelength-selective interference filter 5 is received in a region A1 (hereinafter, the region A1 may be referred to as a light reception region A1). Although described below, a spectral image is obtained in a region A2 that is a predetermined region set inside the light reception region A1 in the present embodiment (hereinafter, the region A2 may be referred to as an image region A2). That is, in the present embodiment, the intensity of light received at each pixel of each of the pixel rows Line J to Line K including the pixels corresponding to the image region A2 is obtained, and the spectral image is obtained on the basis of the intensity of light received.

The light reception region A1 has a shape and size set in accordance with the shape, dimensions (diameters of each of the reflective films 54 and 55), and position of the facing region where the reflective films 54 and 55 of the wavelength-selective interference filter 5 face each other as well as the optical characteristics of the light guiding unit 122. When the light guiding unit 122 is configured to be capable of enlarging and reducing images, the size of the light reception region A1 is set in accordance with the magnification of the light guiding unit 122. The light reception region A1 is a circular region in the present embodiment.

The image region A2 is a region set inside the light reception region A1 and is a square region of a predetermined size inscribed in the light reception region A1 in the present embodiment. The size and shape of the image region A2 can be appropriately set as long as the image region A2 is included in the light reception region A1. For example, in addition to a square, various types of shapes such as an oblong, a trapezoid, and a circle can be employed. When the image region A2 is a rectangular region, the aspect ratio and size of the image region A2 can be appropriately set within the range of the light reception region A1.

### Configuration of Control Unit

FIG. 5 is a block diagram illustrating a schematic configuration of a control system of the spectroscopic camera 10.

As illustrated in FIG. 5, the control unit 14 includes a light source control unit 141, a capture control unit 142, a filter drive unit 143, a drive condition setting unit 144, an image obtaining unit 145, and a storage unit 146. The storage unit 146 stores a variety of data necessary for controlling the spectroscopic camera 10, such as V-λ data indicating the relationship of the wavelength of light transmitted through the wavelength-selective interference filter 5 with respect to a drive voltage applied to the electrostatic actuator 56 of the wavelength-selective interference filter 5.

Each function of the control unit 14 is realized by an operation circuit configured of a CPU or the like and a storage circuit configured of a memory or the like disposed in the circuit substrate 124. The circuit substrate 124 appropriately includes various controller circuits necessary for controlling the spectroscopic camera 10. The circuit substrate 124 is connected to each of the electrode pads 563P and 564P of the wavelength-selective interference filter 5.

The light source control unit 141 controls turning the light source unit 121 on and off.

The capture control unit 142 constitutes a capturing unit of the invention with the capturing element 123 and performs, at a predetermined timing, the light receiving process of accumulating charges corresponding to the intensity of light received at each pixel of the capturing element 123 as well as outputting the detection signal corresponding to the intensity of light received while delaying the light receiving process sequentially for each pixel row.

The filter drive unit 143 corresponds to a spectroscopic control unit of the invention. The filter drive unit 143 performs a wavelength changing drive of setting a target wavelength of light to be acquired by the wavelength-selective interference filter 5 and applying a drive voltage corresponding to the set target wavelength to the electrostatic actuator 56 on the basis of the V-λ data.

As described below, the filter drive unit 143 performs the wavelength changing drive during a period including an invalid frame so that a valid frame and an invalid frame can be alternately repeated in the capturing element 123 driven continuously.

The drive condition setting unit 144 corresponds to a setting unit of the invention and sets the image region A2 where spectral images are obtained. The drive condition setting unit 144 obtains the light reception region A1 from the result of light reception of the capturing element 123 and sets the image region A2 from the light reception region A1. The drive condition setting unit 144 obtains the pixel rows Line J to Line K that are targets of the light receiving process on the basis of the image region A2. The drive condition setting unit 144 sets a capturing period (includes the light exposing period and the light blocking period) according to the frame rate of the capturing element 123 as well as the delay in time between each pixel row and sets a drive timing of the wavelength-selective interference filter 5 on the basis of the capturing period.

The image obtaining unit 145 corresponds to a processing unit of the invention and obtains spectral images by obtaining the intensity of light received at each pixel of the image region A2 on the basis of the detection signal output from the capturing element 123.

The control unit 14 may superimpose and combine spectral images obtained in a plurality of wavelengths, such as each of three colors of red (R), green (G), and blue (B), into a color image and may display the color image on a display unit (not illustrated).

### Drive Timing of Capturing Element and Wavelength-Selective Interference Filter

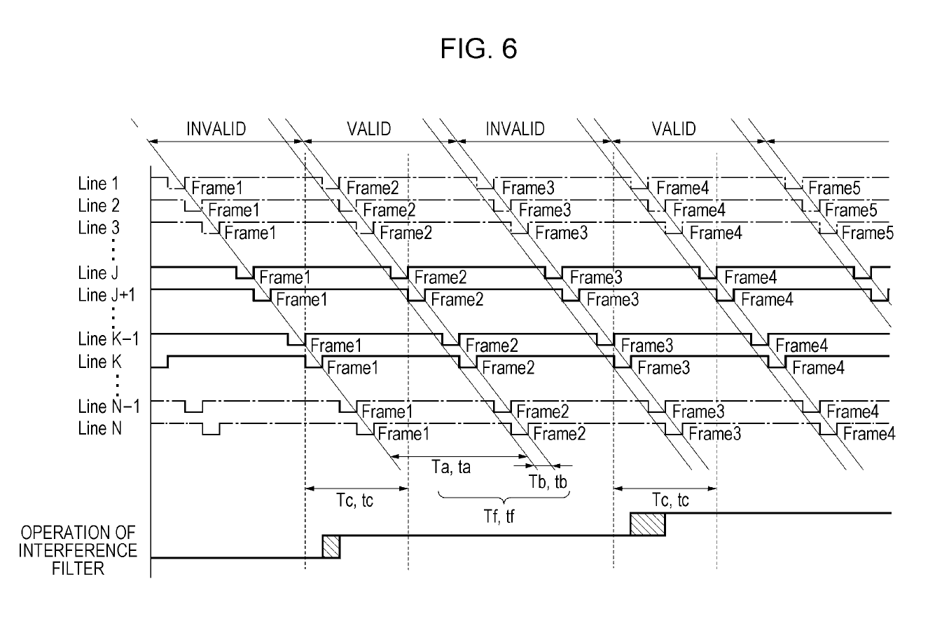

FIG. 6 is a diagram illustrating the relationship between drive timings of the wavelength-selective interference filter 5 and the capturing element 123.

As illustrated in FIG. 6, when the capturing element 123 is controlled by the capture control unit 142 to initiate a capturing process, the capturing element 123 performs the light receiving process of which the processing period per one frame is a capturing period Tf including a light exposing period Ta and a light blocking period Tb, while sequentially delaying the light receiving process by a predetermined period of time for each pixel row from the first pixel row (Line 1) to the last pixel row (Line n).

The target pixel rows Line J to Line K include pixels overlapping with the image region A2 as described above and may be simply referred to as target pixel rows hereinafter. In addition, the pixel row Line J of the target pixel rows from which the light exposing period Ta starts initially may be referred to as a first target pixel row (initial pixel block), and the pixel row Line K from which the light exposing period Ta starts lastly may be referred to as a last target pixel row (last pixel block).

In the present embodiment, as illustrated in FIG. 6, a valid frame in which light of the same wavelength is received in the target pixel rows Line J to Line K and an invalid frame in which the wavelength changing drive is performed on the wavelength-selective interference filter 5 to make the light received in the target pixel rows Line J to Line K have different wavelengths are alternately performed. That is, as illustrated in FIG. 6, a changing period Tc during which the wavelength changing drive is performed is from the end of the light exposing period Ta for the last target pixel row Line K in a valid frame (Frame 2) through an invalid frame (Frame 3) until the start of the light exposing period Ta for the first target pixel row Line J in the subsequent valid frame (Frame 4).

When the wavelength changing drive is performed during the changing period Tc, light of the target wavelength can be received during the period of the pixel rows Line J to Line K related to the image region A2 although light received by the capturing element 123 in the pixel rows Line 1 to Line J−1 and Line K+1 to Line N in the valid frame Frame 2 has a different wavelength from that of light received in the pixel rows Line J to Line K, and a spectral image in the target wavelength can be obtained.

In the present embodiment, as illustrated in FIG. 6, driving is performed at a frame rate twice as fast as a desired frame rate because a spectral image corresponding to one frame is obtained while the light receiving process is performed in two frames.

A required time (capturing time) tf of the capturing period Tf in one pixel row is determined by the frame rate and a delay time Δt between pixel rows. The capturing time tf is the sum of a light exposing time to required for the light exposing period Ta and a light blocking time tb required for the light blocking period Tb as illustrated in an equation (1) below.

The changing period To is a period from the end of the light exposing period Ta for the last target pixel row Line K until the start of the light exposing period Ta for the subsequent first target pixel row Line J. Given that a delay in time between continuous pixel rows is Δt, a required time (changing time) tc of the changing period Tc is represented by an equation (2) below and is further represented by an equation (3) from the relationship represented in the equation (1).

When the changing time tc represented by the equation (3) is longer than the time required for the wavelength changing drive, the wavelength-selective interference filter 5 and the capturing element 123 can be driven in synchronization by alternately repeating the valid frame and the invalid frame as described above.

tf=ta+tb (1)

tc=ta+2·tb−(K−J)·Δt (2)

tc=tf−(K−J)·Δt+tb (3)

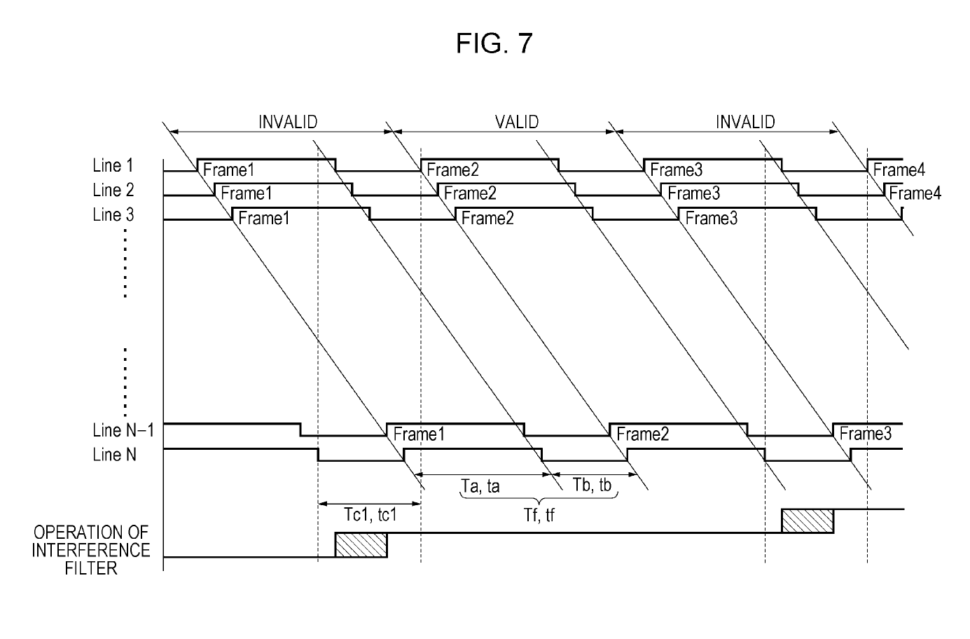

FIG. 7 is a diagram illustrating the relationship between drive timings of the wavelength-selective interference filter 5 and the capturing element 123 in an optical module of the related art.

In the optical module of the related art, as illustrated in FIG. 7, a changing period Tc1 during which the wavelength changing drive is performed is set from the end of the light exposing period for the last pixel row Line N in a valid frame (Frame 2) through an invalid frame (Frame 3) until the start of the light exposing period Ta for the first pixel row Line 1 in the subsequent valid frame (Frame 4).

A changing time tc1 in the optical module of the related art is represented by an equation (4) below and is further represented by an equation (5) below from the relationship represented in the equation (1).

tc1=ta+2·tb−(N−1)·Δt (4)

tc1=tf−(N−1)·Δt+tb (5)

In the optical module of the related art, as illustrated in the equation (5), it is necessary to set the light blocking time tb to be longer so as to secure the changing time tc sufficiently. When the frame rate is fixed, the intensity of light exposure may be decreased to an insufficient extent because the light exposing time ta is shortened. When the intensity of light exposure is insufficient, the frame rate has to be decreased so as to lengthen both of the light exposing time ta and the light blocking time tb by lengthening the capturing time tf required for one frame.

On the contrary, in the present embodiment, the wavelength changing drive is performed during a period other than the light exposing period Ta of the target pixel rows Line J to Line K and is also performed during a part of the period related to the valid frame. Thus, the amount of the changing time tc shortened by the delay in time between pixel rows is less than the changing time tc1 of the related art (refer to the equation (3) and the equation (5)). Thus, the changing time tc can be lengthened compared with that of the related art. Therefore, it is possible to prevent a decrease in the frame rate due to lengthening the light blocking time tb as described above.

### Operation of Spectroscopic Camera

Next, operation of the spectroscopic camera 10 described above will be described below on the basis of the drawings.

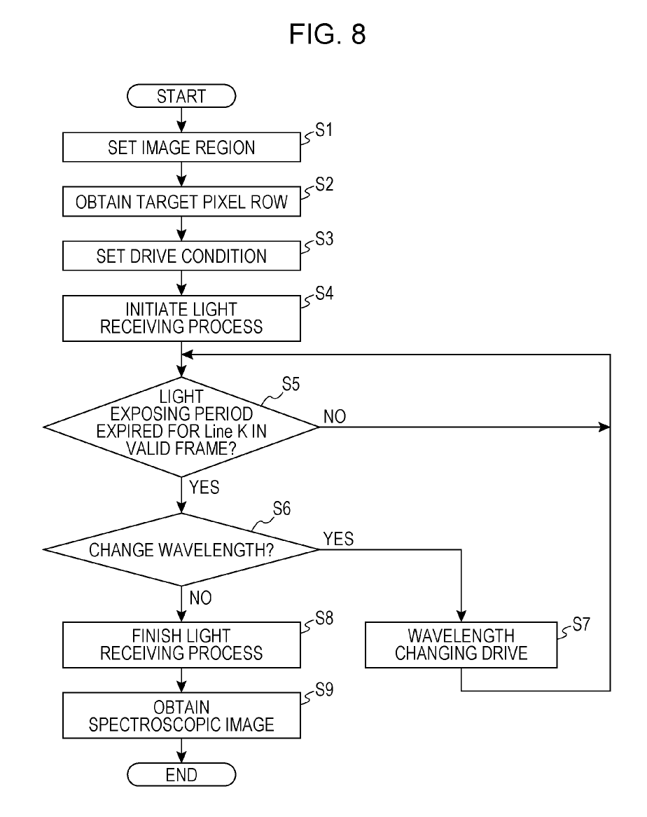

FIG. 8 is a flowchart illustrating an example of the operation of the spectroscopic camera.

When receiving a capturing start instruction from a user, the drive condition setting unit 144 sets the image region A2 (step S1).

The drive condition setting unit 144 obtains the light reception region A1 and sets the image region A2 on the basis of the light reception region A1. The light reception region A1 is a region where light passing through the facing region of the wavelength-selective interference filter 5 is incident and is set in accordance with the external shape of the facing region, the position where the wavelength-selective interference filter 5 is arranged, and the position where images are formed by the light guiding unit 122. The light reception region A1 is obtained by detecting the edges of the light reception region A1 from the result of the light receiving process performed before actual capturing (for example, from a spectral image obtained by capturing reference white for white calibration).

Then, the drive condition setting unit 144 sets a square region inscribed in the obtained light reception region A1 as the image region A2.

The shape and size of the image region A2 can be appropriately set within the range of the light reception region A1. For example, the edge part of the light reception region A1 corresponds to the edge part of the region where the reflective films of the wavelength-selective interference filter 5 face each other. The edge part of the facing region has greater dimensional variations between the reflective films than the central part thereof and thus may have lower spectroscopic accuracy. Therefore, the image region A2 may be set to be inscribed in a circular region inside the light reception region A1 where spectroscopic accuracy is greater than or equal to a desired value. Accordingly, it is possible to prevent a decrease in spectroscopic accuracy.

Next, the drive condition setting unit 144 obtains the target pixel rows, which are targets of the light receiving process, on the basis of the image region A2 set in step S1 (step S2). The target pixel rows include pixels overlapping with the image region A2 and are the pixel rows Line J to Line K as illustrated in FIG. 4.

Next, the capture control unit 142 sets drive conditions on the basis of the result of obtaining of the target pixel rows (Line J to Line K) (step S3). The drive conditions are drive conditions for the capturing element 123 and the wavelength-selective interference filter 5 and, for example, include the frame rate, the light exposing time ta, and the light blocking time tb (capturing time tf) as the drive conditions related to the capturing element 123 and include the start and end timings of the changing period Tc as the drive conditions related to the wavelength-selective interference filter 5.

As described above, since an image corresponding to one frame is obtained in two frames, driving is performed at a frame rate twice as fast as the actual frame rate to have a desired frame rate, and the capturing time tf per frame in one pixel row is defined in accordance with this frame rate. The delay time Δt is the time required for transmission of charges and is set in advance.

Meanwhile, the light blocking time tb is changeable and is set such that the changing time tc is longer than or equal to the time required for the wavelength changing drive. For example, as illustrated in the equation (3), the changing period Tc can be lengthened without changing the frame rate by lengthening the light blocking time tb.

The light exposing time to can be lengthened by shortening the light blocking time tb. For example, by setting the light blocking time tb to a maximum value of the time required for the wavelength changing drive, the light blocking time tb can be set to be shorter while performing the wavelength changing drive on the target pixel rows in the valid frame is prevented. Accordingly, it is possible to prevent the intensity of light exposure becoming insufficient that occurs when the light exposing time is shortened by lengthening the light blocking time.

Next, the filter drive unit 143 applies a voltage corresponding to the set wavelength to the electrostatic actuator 56 to change the dimensions of the gap G1. Then, the capture control unit 142 sequentially initiates the light receiving process in each pixel row of the capturing element 123 (step S4).

While the capture control unit 142 does not accumulate charges in the pixel rows Line 1 to Line J−1 and Line K+1 to Line N in the present embodiment, the capturing period Tf is set for all of the pixel rows in the same manner as if all of the pixel rows Line 1 to Line N are sequentially delayed in the usual rolling shutter method.

Charges may also be accumulated in the pixel rows Line 1 to Line J−1 and Line K+1 to Line N during the light exposing period Ta. In this case, the detected intensity of light received in the pixel rows Line 1 to Line J−1 and Line K+1 to Line N is not employed in obtaining spectral images.

Next, the capture control unit 142 determines whether or not the light exposing period Ta is finished in the last target pixel row Line K in the valid frame (step S5) and, when the light exposing period Ta is not finished in Line K (NO in step S5), repeats the determination until the light exposing period Ta is finished in Line K. The determination of whether or not the light exposing period Ta is finished in Line K may be performed by obtaining the end timing of the light exposing period Ta in Line K on the basis of each period set in advance or may be performed by detecting the end of the light exposing period Ta in line K in synchronization with driving of the capturing element 123, that is, on the basis of the start of the light blocking period Tb in Line K.

When the capture control unit 142 determines that the light exposing period Ta is finished in Line K (YES in step S5), the filter drive unit 143 determines whether or not it is necessary to change the wavelength by performing the wavelength changing drive (step S6).

The filter drive unit 143 determines that changing the wavelength is required (YES in step S6) when, for example, spectral images are not obtained yet in all of the target wavelengths or when an instruction to finish the obtaining is not received yet and performs the wavelength changing drive on the wavelength-selective interference filter 5 (step S7).

That is, the filter drive unit 143, after the end of the light exposing period Ta in the last target pixel row Line K, applies a drive voltage corresponding to the subsequent target wavelength to the electrostatic actuator and performs the wavelength changing drive. The wavelength changing drive starts from the end of the valid frame including the pixel row Line K, continues through the invalid frame, and ends before the start of the light exposing period Ta for the first target pixel row Line J in the subsequent valid frame. Then, the dimensions of the gap G1 of the wavelength-selective interference filter 5 are set in correspondence with the subsequent target wavelength.

Meanwhile, when it is determined that the wavelength changing drive is not required (NO in step S6), the capture control unit 142 finishes the light receiving process of the capturing element 123 (step S8).

Then, the image obtaining unit 145 obtains the intensity of light at each pixel corresponding to the image region A2 on the basis of the detection signal obtained until the end of the light exposing process and obtains a spectral image (step S9).

Obtaining the spectral image may be performed each time the detection signals are obtained from all of the target pixel rows in one frame.

### Effect of First Embodiment

In the present embodiment, the wavelength changing drive is performed during the period from the end of the light exposing period Ta in the last target pixel row Line K until the start of the light exposing period in the subsequent first target pixel row Line J among the plurality of pixel rows Line J to Line K of the capturing element 123 overlapping with the image region A2 included in the light reception region A1 for reception of emitted light.

In such a configuration, a valid frame where a spectral image in a predetermined region is obtained by sequentially delaying the processing performed during the capturing period Tf in the plurality of pixel rows and an invalid frame where the wavelength changing drive is performed are repeated, and an image corresponding to one frame is obtained by driving in two frames. At this time, the wavelength changing drive is performed during the period from the end of the light exposing period Ta for the last target pixel row Line K in the valid frame through the period of the invalid frame until the start of the light exposing period Ta for the first target pixel row Line J in the valid frame. Therefore, the wavelength changing drive can be performed even in a part of the valid frame, and the changing period Tc during which the wavelength changing drive can be performed can be lengthened in comparison with a case, for example, where the wavelength changing drive is performed from the end of the light exposing period Ta in the last pixel row Line N of all of the pixel rows until the start of the light receiving process in the subsequent valid frame. Accordingly, it is possible to prevent a decrease in the frame rate due to performing the wavelength changing drive.

In the present embodiment, the light reception region A1 is obtained on the basis of the detection signal, and the image region A2 is set on the basis of the light reception region A1. The pixel rows overlapping with the set image region A2 are targets of the light receiving process. In such a configuration, for example, even if the light reception region A1 is changed, the target pixel rows can be set in accordance of the changed light reception region A1. Therefore, it is possible to prevent a problem such that a part of the spectral image is missing due to the light receiving process not being performed in all of the target pixel rows of the light receiving process because of the change of the light reception region A1, and the spectral image can be obtained appropriately.

In the present embodiment, the light receiving process is performed in all of the pixel rows Line 1 to Line N. That is, in the present embodiment, the capturing element 123 is driven during the capturing period Tf in a sequentially delayed manner in all of the pixel rows Line 1 to Line N. The wavelength changing drive is performed during the period from the end of the light exposing period Ta for the last target pixel row Line K until the start of the light exposing period Ta for the first target pixel row Line J in the valid frame.

In such a configuration, since the capturing element 123 is driven in an usual manner in which all of the pixel rows are targets of the light receiving process, adjusting the drive timings of the wavelength-selective interference filter 5 and the capturing element 123 can be simplified in comparison with a case where the manner of driving the capturing element 123 changes each time the target pixel row changes, and it is possible to prevent an increase in processing load.

### Second Embodiment

Hereinafter, a second embodiment of the invention will be described on the basis of the drawings.

In the first embodiment, the wavelength changing drive is performed on the wavelength-selective interference filter 5 during the period other than the light exposing period for the target pixel rows Line J to Line K in the valid frame while the light processing process is performed for all of the pixel rows Line 1 to Line N in each frame.

The second embodiment is different in that the number of target pixel rows of the light receiving process is decreased by performing the light receiving process only in the target pixel rows Line J to Line K of all of the pixel rows Line 1 to Line N. Other configurations are basically the same as those of the first embodiment. The same configuration as the first embodiment will be designated by the same reference sign and either will not be described or will be described in a simplified manner.

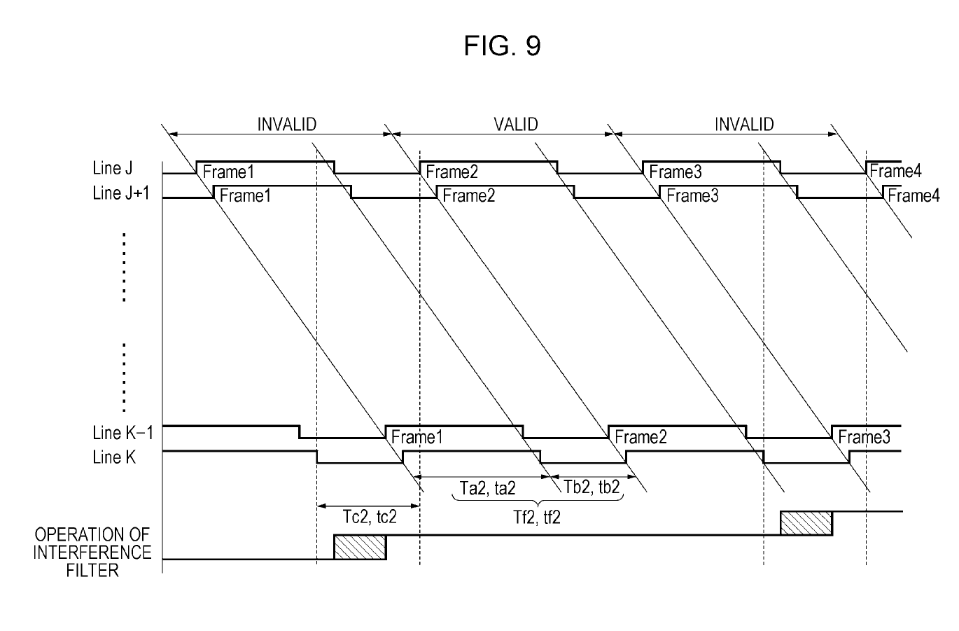

FIG. 9 is a diagram illustrating the relationship between drive timings of the wavelength-selective interference filter 5 and the capturing element 123.

In the second embodiment, as illustrated in FIG. 9, the light receiving process is performed in the pixel rows Line J to Line K. That is, the light receiving process is not performed (capturing period is not set) in the pixel rows Line 1 to Line J−1 and the pixel rows Line K+1 to Line N. When the capturing element 123 is driven as such, given that the changing time is tc2 and the capturing time is tf2, the changing time tc2 can be represented by an equation (6) below like the equation (3). As illustrated in the equation (6), the changing time tc2 can be set to be longer than the changing time tc1 of the related art, and it is possible to prevent a decrease in the frame rate.

tc2=tf2−(K−J)·Δt+tb2 (6)

In the present embodiment, by performing the light receiving process in the pixel rows Line J to Line K, the number of target pixel rows of the light receiving process can be decreased in comparison with a case where the light receiving process is performed in all of the pixel rows. In the rolling shutter method, the time required for one frame includes the capturing time tf2 and the cumulative total of the delay time Δt between pixel rows (proportional to the number of target pixel rows). As described above, the number of target pixel rows can be decreased in the present embodiment. Thus, when the frame rate is fixed, the capturing time tf2 can be lengthened in comparison with the case where the light receiving process is performed in all of the pixel rows.

In the spectroscopic camera 10 of the present embodiment, the drive condition setting unit 144 obtains the light receiving region A1 to set the image region A2 and obtains the target pixel rows Line J to Line K of the light receiving process in the same manner as the first embodiment.

In the present embodiment, the drive condition setting unit 144 sets the capturing period in only the target pixel rows Line J to Line K of the light receiving process as drive conditions for the capturing element 123. That is, the drive condition setting unit 144 obtains the capturing time tf2 (the light exposing time ta2 and the light blocking time tb2) when setting the capturing period only in the pixel rows Line J to Line K according to the frame rate of the capturing element 123 as well as the delay in time between each pixel row and sets the capturing period as a capturing period Tf2. Then, the drive condition setting unit 144 sets the drive timing of the wavelength-selective interference filter 5 on the basis of the capturing period Tf2.

The capture control unit 142 causes the light receiving process to be performed in the target pixel rows Line J to Line K on the basis of the drive conditions set by the drive condition setting unit 144.

The spectroscopic camera 10 of the present embodiment, in the same procedure as the first embodiment illustrated in FIG. 8, sets the image region A2 (step S1) and obtains the target pixel rows Line J to Line K (step S2). Then, as described above, the drive conditions for the wavelength-selective interference filter 5 and the capturing element 123 are set (step S3). In the second embodiment, the light receiving process is performed in the target pixel rows Line J to Line K (step S4).

Afterward, in the same manner as the first embodiment, steps S5 to S7 are repeated until obtaining of the spectral image is finished. When the obtaining is finished, the light receiving process is finished (step S8), and the spectral image is obtained in the image region A2 (step S9).

### Effect of Second Embodiment

In the present embodiment, the light receiving process is performed in the pixel rows Line J to Line K overlapping with the image region A2 of all of the pixel rows of the capturing element 123 and obtains the spectral image corresponding to the image region A2 on the basis of the detection signal obtained.

Even in such a configuration, the changing period Tc can be lengthened in comparison with the case, for example, where the wavelength changing drive is performed from the end of the light exposing period Ta in the last pixel row Line N of all of the pixel rows until the start of the light exposing period Ta for the first pixel row Line 1 in the subsequent valid frame. That is, the number of target pixel rows of the light receiving process in one frame can be decreased in the present embodiment. As the number of target pixel rows is smaller, the amount of the changing period Tc shortened in accordance with the cumulative total of the delays in time provided between pixel rows can be decreased, and the changing period can be lengthened.

In addition, since the number of target pixel rows of the light receiving process can be decreased, the capturing time tf2 set with respect to a predetermined frame rate and the delay time Δt can be lengthened in comparison with the case where the light receiving process is performed in all of the pixel rows as described above. Therefore, the light exposing period Ta and the light blocking period Tb can be set to be longer, and it is possible to prevent a decrease in the frame rate.

Furthermore, as described above, since the number of target pixel rows can be decreased, the number of detection signals obtained can be decreased, and the processing load can be reduced.

### Modification of Embodiments

The invention is not limited to each of the above embodiments as well as modification examples and includes modifications, improvements, and the like carried out to an extent capable of achieving the advantage of the invention.

The invention is not limited to each of the embodiments in which the image region A2 of a square shape inscribed in the light reception region A1 is set as the predetermined region corresponding to the light reception region A1.

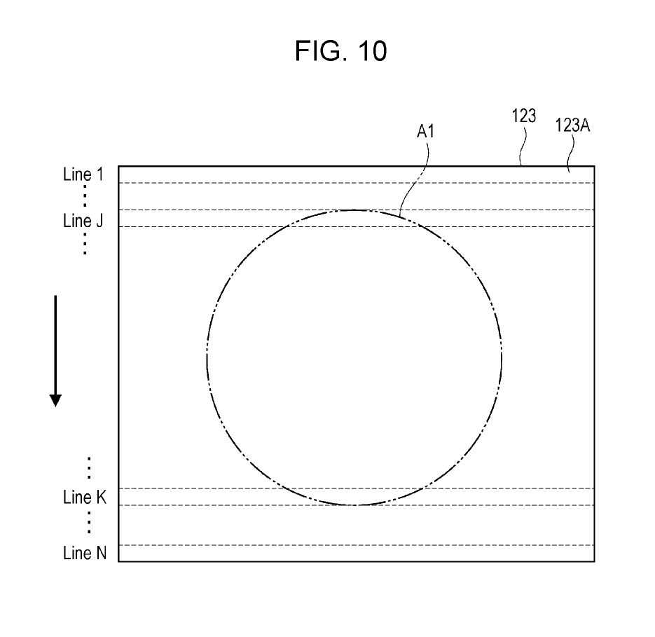

FIG. 10 is a diagram illustrating another example of the relationship between the light reception region and the target pixel rows of the light receiving process. As illustrated in FIG. 10, for example, the entire light reception region A1 may be set as the predetermined region. In this case, the pixel rows overlapping with the light reception region A1 are target pixel rows of the light receiving process. By configuring the entire light reception region A1 as a capturing target, efficiency in use of light emitted from the wavelength-selective interference filter 5 can be improved.

The invention is not limited to each of the embodiments illustrated by the configuration in which the region setting process of obtaining the light reception region A1 to set the image region A2 and the condition setting process of setting drive conditions on the basis of the setting process are performed each time the spectral image is obtained. For example, those processes may be configured to be performed at a predetermined timing such as when the spectroscopic camera 10 is initially booted, when a user instruction to perform the processes is detected, or when the ratio of enlargement (ratio of reduction) is changed by the light guiding unit. Accordingly, the timing of performing the region setting process and the condition setting process can be optimized, and it is possible to reduce the processing load while preventing missing spectral images caused when the light receiving process is not performed in the pixel rows overlapping with the image region A2.

Alternatively, a detecting unit detecting the change of the light reception region A1 may be provided to perform the region setting process at the time of detection of the change.

For example, the first embodiment is illustrated by the configuration in which the spectral image is obtained on the basis of the intensity of light received in the target pixel rows Line J to Line K by performing the light receiving process in all of the pixel rows. In addition to such a configuration, a detecting unit may be provided to detect the change of the light reception region A1 by detecting the change of the position of the edges of the light reception region A1 on the basis of the detected intensity of light received in the target pixel rows Line J to Line K and in at least a part of the other pixel rows Line 1 to Line J−1 and Line K+1 to Line N. By performing the region setting process on the basis of the detection result, each of the above processes can be performed at an appropriate timing.

The invention is not limited to each of the embodiments illustrated by one pixel row configured as one pixel block. For example, two or more pixel rows of a rolling shutter capturing element may be configured as one pixel block.

While each of the embodiments is illustrated by the spectroscopic camera 10 as an example, the invention can be applied to an analyzing device that, for example, analyzes the components of a measuring target.

In addition, while each of the embodiments is illustrated by the spectroscopic camera 10 obtaining the spectral image on the basis of the detection signal, the spectroscopic camera 10 may be configured to be capable of obtaining the spectrum of a measuring target. That is, the spectroscopic camera 10 may be configured to obtain the intensity of light in each wavelength on the basis of the detection signal from the pixels in each wavelength.

In each of the embodiments, for example, the wavelength-selective interference filter 5 may be configured to be incorporated into the spectroscopic camera 10 while being accommodated in a package. In this case, by making a vacuum in the package airtightly, drive response can be improved when voltage is applied to the electrostatic actuator 56 of the wavelength-selective interference filter 5.

The invention is not limited to each of the embodiment in which the wavelength-selective interference filter 5 is configured to include the electrostatic actuator applying voltage to change the dimensions of the gap between the reflective films 54 and 55.

For example, the wavelength-selective interference filter 5 may be configured to employ a dielectric actuator in which a first dielectric coil is arranged instead of the fixed electrode 561 as well as a second dielectric coil or a permanent magnet arranged instead of the movable electrode 562.

Further alternatively, the wavelength-selective interference filter 5 may be configured to employ a piezoelectric actuator instead of the electrostatic actuator 56. In this case, the holding portion 522 can be bent by arranging laminated layers of a lower electrode layer, a piezoelectric film, and an upper electrode layer and by changing an input value of the voltage applied between the lower electrode layer and the upper electrode layer to expand or contract the piezoelectric film.

The invention is not limited to each of the embodiments illustrated by the wavelength-selective interference filter 5, configured as a Fabry-Pérot etalon, in which the fixed substrate 51 and the movable substrate 52 facing each other are bonded together with the fixed reflective film 54 and the movable reflective film 55 respectively disposed in the fixed substrate 51 and the movable substrate 52.

For example, without bonding the fixed substrate 51 and the movable substrate 52 together, the wavelength-selective interference filter 5 may be configured to include a gap changing unit such as a piezoelectric element between the substrates to change the gap between the respective reflective films thereof.

In addition, the invention is not limited to the configuration of the wavelength-selective interference filter 5 configured of two substrates. For example, a wavelength-selective interference filter in which two reflective films are laminated on one substrate through a sacrificial layer that is removed by etching or the like to form a gap therebetween may be employed.

The invention is not limited to each of the embodiments illustrated by the wavelength-selective interference filter 5 configured as a spectroscopic element. For example, an acousto-optic tunable filter (AOTF) or a liquid crystal tunable filter (LCTF) may be employed instead. However, it is preferable to employ a Fabry-Pérot filter such as in each of the embodiments from the viewpoint of reducing the size of the device.

Other specific structures employed in embodying the invention may be configured by appropriately combining each of the embodiments and modification examples to an extent capable of achieving the advantage of the invention and may be appropriately changed to another structures and the like.

The entire disclosure of Japanese Patent Application No. 2014-218486 filed on Oct. 27, 2014 is expressly incorporated by reference herein.

What is claimed is:

1. An optical module comprising:
a spectroscopic element that is capable of selecting light of a predetermined wavelength from incident light and changing the wavelength of emitted light;
a rolling shutter capturing element that includes pixels accumulating charges when being exposed to the emitted light and in which a light receiving process including a light exposing period for accumulating charges at the pixels as well as a light blocking period for outputting a detection signal corresponding to the charges accumulated during the light exposing period is sequentially performed in a delayed manner per pixel block configured of a plurality of the pixels; and
a spectroscopic control unit that controls a wavelength changing drive of changing the wavelength of the emitted light in the spectroscopic element,
wherein the capturing element includes, as a plurality of pixel blocks overlapping with a predetermined region set in a light reception region for the emitted light, an initial pixel block where the light receiving process is initially performed and a last pixel block where the light receiving process is lastly performed, and
the spectroscopic control unit performs the wavelength changing drive during a period from end of the light exposing period in the last pixel block until subsequent start of the light exposing period in the initial pixel block.

2. The optical module according to claim 1, further comprising:
a setting unit that obtains the light reception region on the basis of the detection signal from the capturing element and sets the predetermined region on the basis of the light reception region.

3. The optical module according to claim 1, further comprising:
a capture control unit that causes the light receiving process to be performed in all of the pixel blocks which the capturing element includes.

4. The optical module according to claim 1, further comprising:
a capture control unit that causes the light receiving process to be performed in a plurality of pixel blocks overlapping with the predetermined region of all of the pixel blocks which the capturing element includes.

5. An electronic device comprising:
a spectroscopic element that is capable of selecting light of a predetermined wavelength from incident light and changing the wavelength of emitted light;
a rolling shutter capturing element that includes pixels accumulating charges when being exposed to the emitted light and in which a light receiving process including a light exposing period for accumulating charges at the pixels as well as a light blocking period for outputting a detection signal corresponding to the charges accumulated during the light exposing period is sequentially performed in a delayed manner per pixel block configured of a plurality of the pixels;
a spectroscopic control unit that controls a wavelength changing drive of changing the wavelength of the emitted light in the spectroscopic element; and
a processing unit that performs processing based on the detection signal,
wherein the capturing element includes, as a plurality of pixel blocks overlapping with a predetermined region set in a light reception region for the emitted light, an initial pixel block where the light receiving process is initially performed and a last pixel block where the light receiving process is lastly performed, and
the spectroscopic control unit performs the wavelength changing drive during a period from end of the light exposing period in the last pixel block until subsequent start of the light exposing period in the initial pixel block.

6. A method for driving an optical module that includes
a spectroscopic element which is capable of selecting light of a predetermined wavelength from incident light and changing the wavelength of emitted light,
and a rolling shutter capturing element which includes pixels accumulating charges when being exposed to the emitted light and in which a light receiving process including a light exposing period for accumulating charges at the pixels as well as a light blocking period for outputting a detection signal corresponding to the charges accumulated during the light exposing period is sequentially performed in a delayed manner per pixel block configured of a plurality of the pixels,
wherein the capturing element includes, as a plurality of pixel blocks overlapping with a predetermined region set in a light reception region for the emitted light, an initial pixel block where the light receiving process is initially performed and a last pixel block where the light receiving process is lastly performed, and
the method comprises:
accumulating charges in a delayed manner by a predetermined time at the pixels of a plurality of pixel blocks, of all of the pixel blocks that the capturing element includes, including the pixel blocks overlapping with the predetermined region included in the light reception region for the emitted light; and
performing a wavelength changing drive of changing the wavelength of the emitted light on the spectroscopic element during a period from end of the light exposing period in the last pixel block until subsequent start of the light exposing period in the initial pixel block.
